(19) United States
(12) Patent Application Publication
(10) Pub. No.: US 2018/0237093 A1
(43) Pub. Date: Aug. 23, 2018

(54) SELF-POWERING WARNING DEVICE

(71) Applicant: TE-SHENG CHEN, New Taipei (TW)

(72) Inventor: TE-SHENG CHEN, New Taipei (TW)

(21) Appl. No.: 15/898,149

(22) Filed: Feb. 15, 2018

(30) Foreign Application Priority Data
Feb. 21, 2017 (TW) 106202504

(51) Int. Cl. B62J 6/06; B62J 6/20; B62J 6/00; H02K 7/18

(52) U.S. Cl. CPC B62J 6/06; H02K 7/1807; B62J 6/001; B62J 6/20

(57) ABSTRACT

The present invention provides a self-powering warning device comprising a driving wheel and a fixing component. The driving wheel has at least one powering module and at least one light-emitting module provided therein; the powering module can generate an induced voltage for driving the light-emitting module, and the fixing component can be mutually assembled with the driving wheel and provided on a vehicle, so as to rotate the driving wheel when the vehicle travels and drive the light-emitting module, thereby generating the induced voltage for providing an electrical energy to the light-emitting module, and thus generating an illuminating and warning effect.

### BACKGROUND OF THE INVENTION

### a) Field of the Invention

The present application is related to a warning device, and more particularly to a self-powering warning device applicable to a vehicle.

### b) Description of the Prior Art

In response to the environmental protection policies aimed at saving energy and reducing carbon emissions introduced by the governments around the world, bicycle riding has recently become a popular sport for everyone. However, the trend has also led to a significant increase in bicycle-related accidents globally.

Though the prior art has provided a technical solution of providing a warning device on a rear part of a bicycle, a passive warning device is therein such as a light-reflecting panel and a light-reflecting sticker cannot generate light by themselves, and are only effective when there is light illuminated thereon, while an active warning device therein such as a light having a battery for power supply leads to problems like a battery is a consumable which expires after a certain period, and causes pollution harmful to people and environment if discarded casually.

Therefore, a vehicle illuminating device of the prior art generally includes a suspension arm, an illuminating light and a powering unit, wherein the suspension arm is fixed on a frame of a bicycle for supporting the powering unit to normally press against a position of the rim of the bicycle, and the powering unit includes an induction coil set, a magnetic disc and a roller. The induction coil set is coiled around a circling shaft, and a rotating shaft of the magnetic disc is perpendicular to the circling shaft, wherein the rotation of the wheel drives the roller and the magnetic disc to rotate relative to the induction coil set, such that the induction coil set generates an induced electrical energy for providing power to the illuminating light.

Yet the above-mentioned device still has shortcomings such as being unable to be detached, having an unstable illumination and being unable to store power or lacking a braking warning. Therefore, a novel self-powering warning device is urgently required in the field.

### SUMMARY OF THE INVENTION

To effectively solve the aforesaid problems, a primary objective of the present invention is to provide a self-powering warning device which is capable of self-powering for warning during riding and can be conveniently detached and provided on a vehicle.

Another objective of the present invention is to provide a self-powering warning device having a power storage function and a brake warning function.

A further objective of the present invention is to provide a self-powering warning device which is capable of solving the issues of a wiring requirement and noise generation, having a physical message radio transceiving function and a voltage output function.

To achieve the above-mentioned objectives, the present invention provides a self-powering warning device comprising a driving wheel and a fixing component; the driving wheel has at least one powering module and at least one light-emitting module provided therein; the powering module can generate an induced voltage for driving the light-emitting module, and the fixing component can be assembled and provided on a vehicle; the driving wheel is pivotally connected to the fixing component is and connected to a wheel of the vehicle, such that when the vehicle travels, the driving wheel is rotated by the wheel, so as to drive the powering module to generate the induced voltage for providing an electrical energy to the light-emitting module, and thus generating an illuminating and warning effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic local assemblage view I according to a preferred embodiment of the present application.

FIG. 2 is a schematic local assemblage view II according to a preferred embodiment of the present application.

FIG. 3 is a schematic block view I according to a preferred embodiment of the present application.

FIG. 4 is a schematic block view II according to a preferred embodiment of the present application.

FIG. 5 is a schematic view I showing an implementation of assem bly according to a preferred embodiment of the present application.

FIG. 6 is a schematic view II showing an it nplementation of asse bly according to a preferred embodiment of the present application.

FIG. 7 is a schematic view III showing an implementation of assembly according to a preferred embodiment of the present application.

FIG. 8 is a schematic view IV showing an implementation of assembly according to a preferred embodiment of the present application.

FIG. 9 is a schematic view V showing an implementation of assembly according to a preferred embodiment of the present application.

FIG. 10 is a schematic block view III according to a preferred embodiment of the present application.

FIG. 11 is a schematic block view IV according to a preferred embodiment of the present application.

FIG. 12 is a schematic block view V according to a preferred embodiment of the present application.

FIG. 13 is a schematic view VI showing an implementation of assembly according to a preferred embodiment of the present application.

### DETAILED DESCRIPTION OF THE PREFERRED EMBODIMENTS

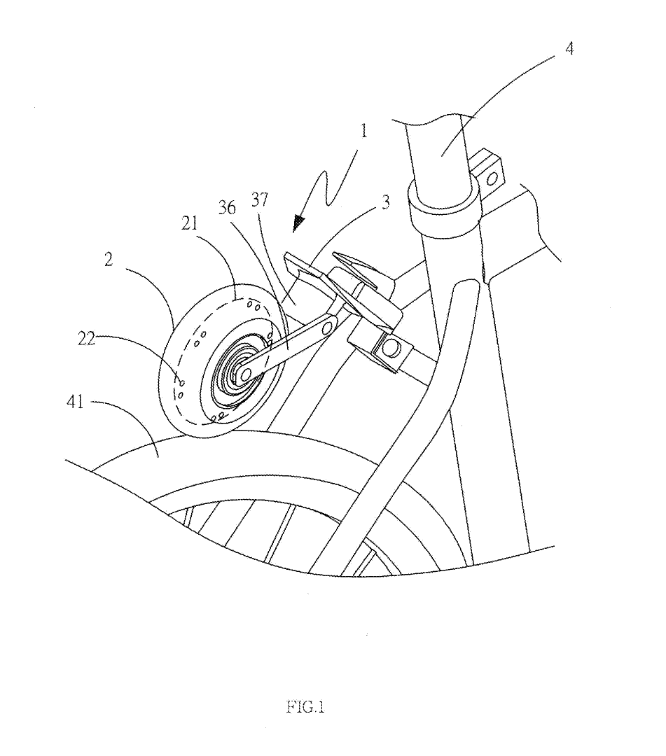

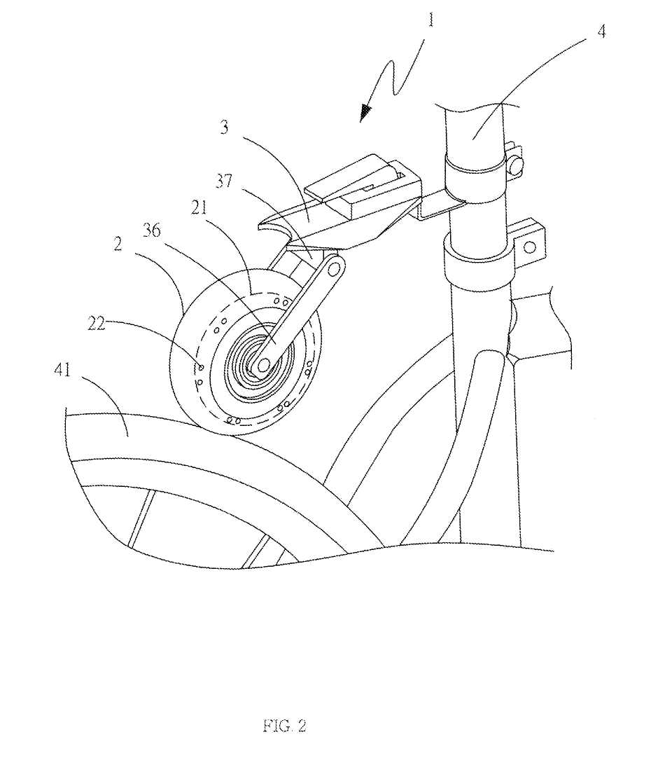

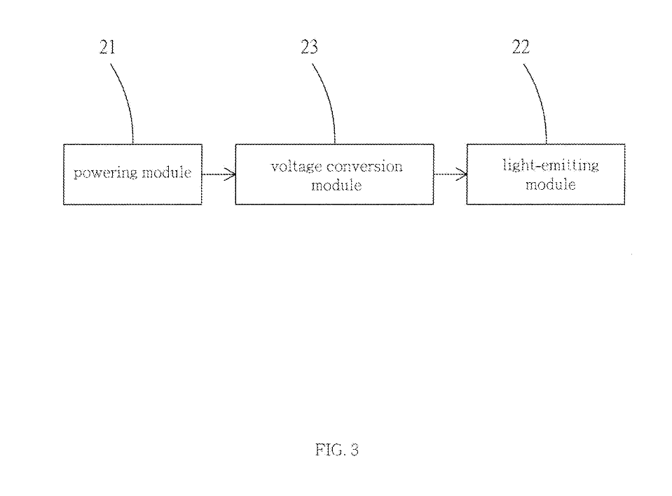

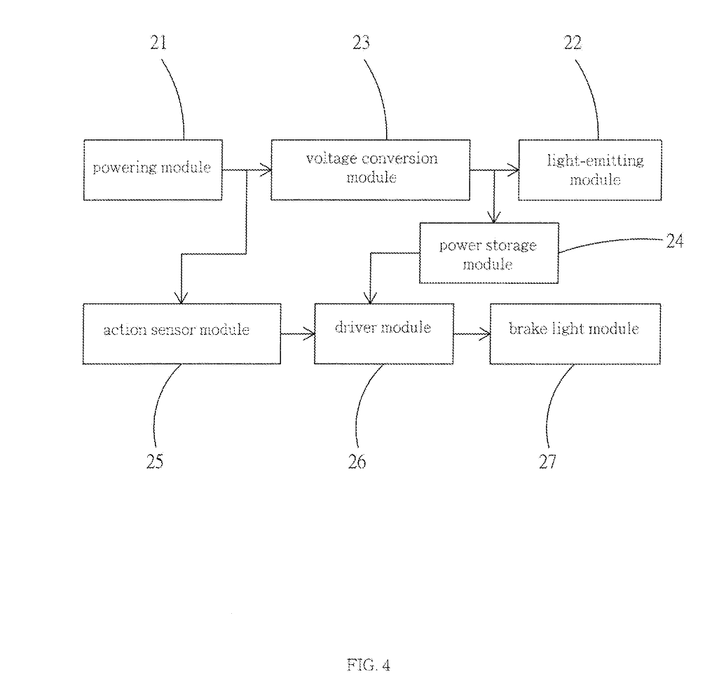

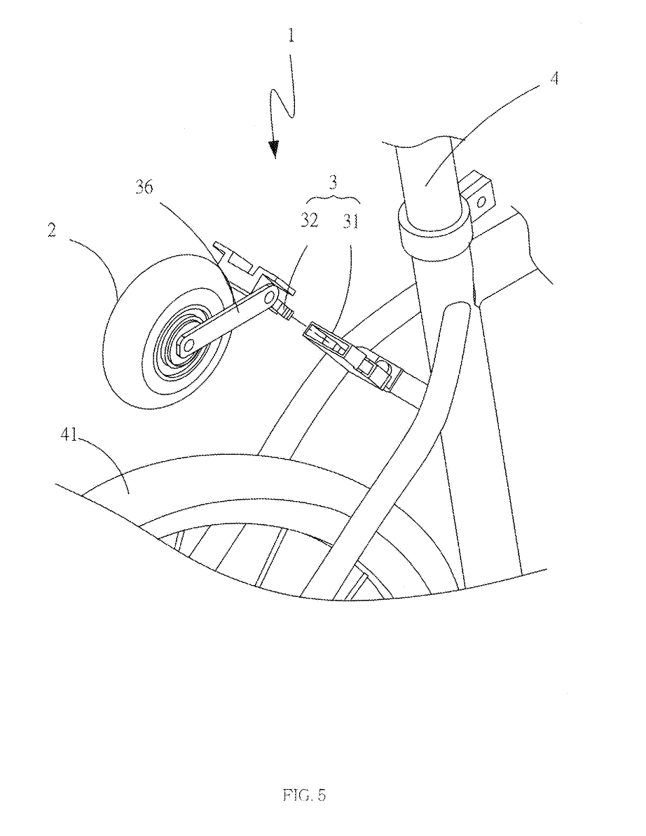

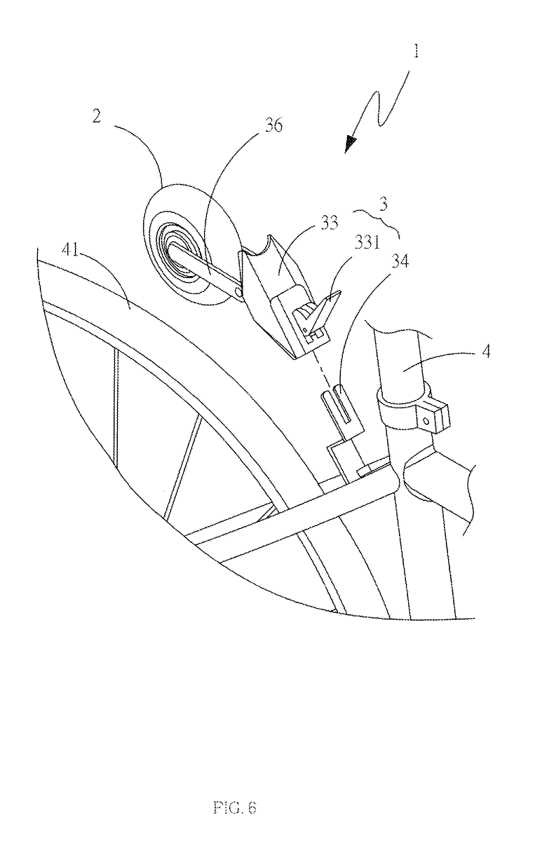

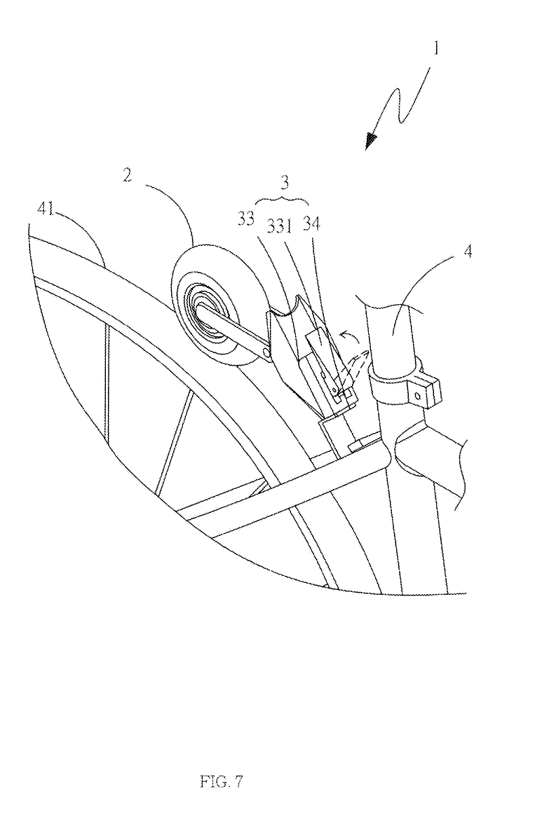

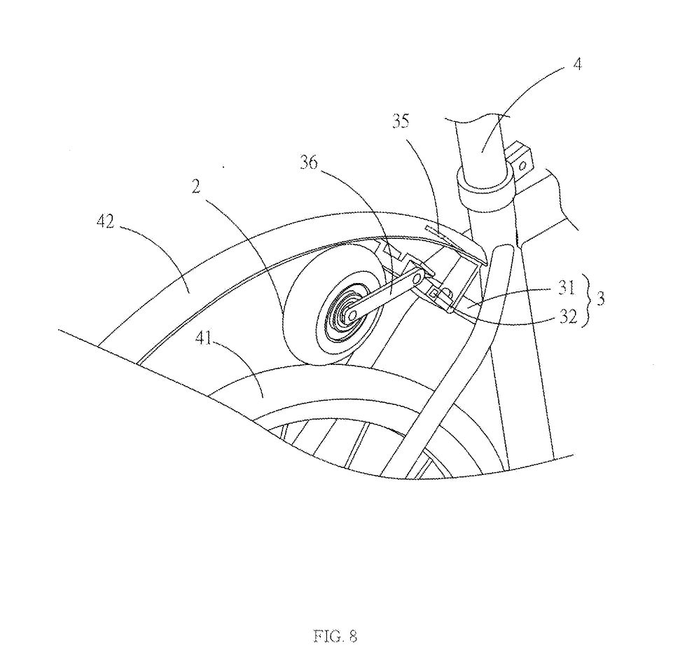

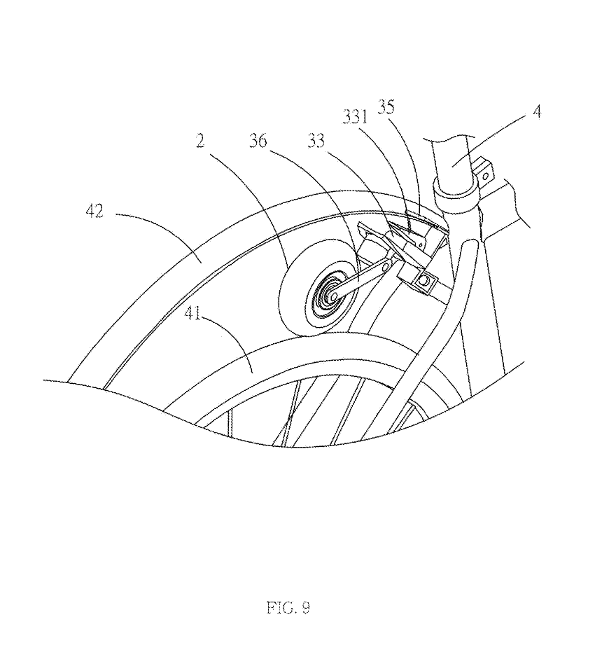

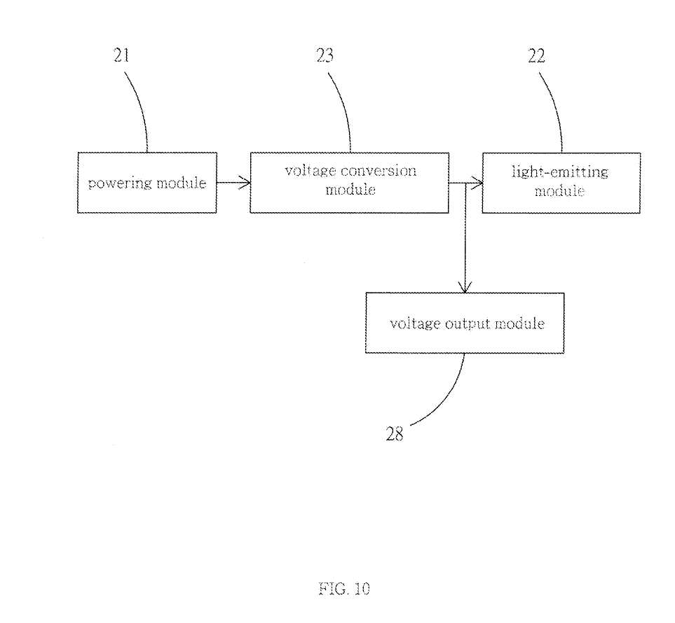

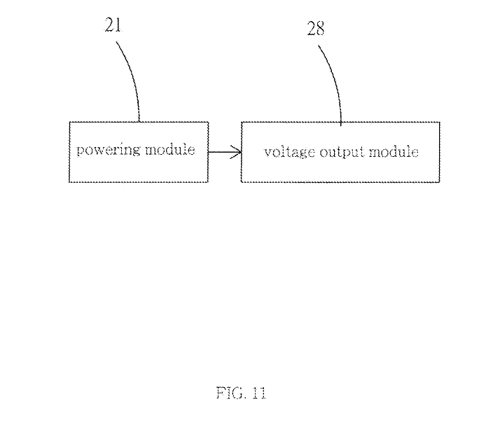

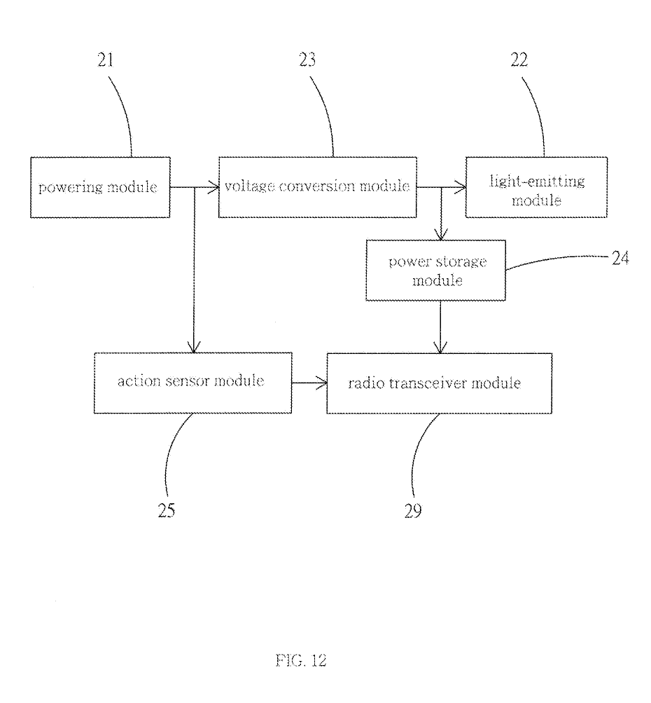

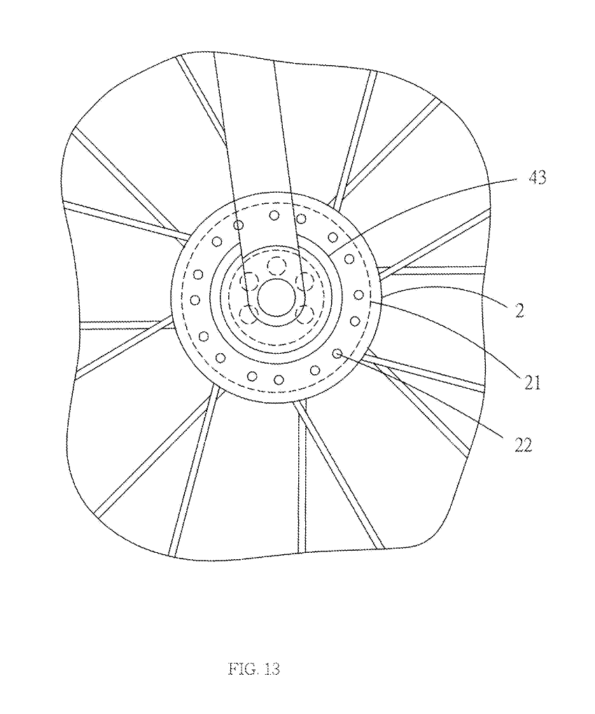

Refer to FIGS. 1 to 13, which are the schematic local assemblage views I and II, the schematic block views I to V, and the schematic views I to VI showing an implementation of assembly according to a preferred is embodiment of the present application. It can be noted from the figures that the self-powering warning device 1 comprises a driving wheel 2 and a fixing component 3, wherein the driving wheel 2 has at least one powering module 21 and at least one light-emitting module 22 provided therein, and the powering module 21 can generate an induced voltage for driving the light-emitting module 22, while the fixing component 3 can be assembled and provided on a vehicle 4; the driving wheel 2 is pivotally connected to the fixing component 3 by means of at least one set of assembling pieces 36 and is in contact with an outer circumferential surface of a wheel 41 of the vehicle 4; the driving wheel 2 further has a voltage conversion module 23, a power storage module 24 and a voltage output module 28, in which the voltage conversion module 23 receives and converts the induced voltage into an output voltage for driving the light-emitting module 22; the power storage module 24 is coupled to the voltage conversion module 23 and provides power storage, and the voltage output module 28 is coupled to the voltage conversion module 23 and supplies power to an external device (not shown in the figures).

The driving wheel 2 is pivotally connected to the assembling pieces 36 and connected to the wheel 41 of the vehicle 4; a bicycle is used as is an example in the embodiment but is not limited thereto. When the vehicle 4 travels, the driving wheel 2 is rotated by means of the wheel 41 for driving the powering module 21 to generate the induced voltage, so as to provide an electrical energy to the light-emitting module 22 and produce an illuminating and warning effect. Moreover, the powering module 21 further has a stator and a plurality of coils (not shown in the figures); when the driving wheel 2 rotates, the coils are rotated along and enabled to generate an alternating magnetic field with the stator, so as to generate an alternating current. This is a technology of the prior art and will not be further described here.

The driving wheel 2 further has an action sensor module 25, a driver module 26 and a brake light module 27, wherein the action sensor module 25 is coupled to the powering module 21 for detecting a rotation signal of the wheel 41, and the driver module 26 is coupled to the action sensor module 25, the power storage module 24 and the brake light module 27, such that when the action sensor module 25 senses a braking signal, power can be supplied to the driver module 26 via the power storage module 24, which drives the brake light module 27 to generate a brake light illuminating and warning effect, wherein the braking signal is generated when the wheel 41 of the vehicle 4 is decelerates or stops rotating.

Further, the driving wheel 2 further comprises a radio transceiver module 29, and the radio transceiver module 29 is coupled to the action sensor module 25 and the power storage module 24, wherein the power storage module 24 can supply power to the radio transceiver module 29 and the action sensor module 25, in which the action sensor module 25 can sense an action state of the vehicle 4, such that when the action sensor module 25 detects a physical signal such as a speed, a distance or a halt for instance but not limited thereto, the action sensor module 25 which sensed the action state sends a sensed signal to the radio transceiver module 29, and then the radio transceiver module 29 sends the sensed signal to the external device (not shown in the figures); the action sensor module 25 comprises a micro-controller (not shown in the figures) or an electronic circuit (not shown in the figures), and the action sensor module 25 is carried on a printed circuit board (not shown in the figures) of the driving wheel 2.

Further, a lateral side of the fixing component 3 has a horizontal rod 37 formed thereon, and an end of each of the assembling pieces 36 is pivotally connected to the horizontal rod 37 of the fixing component 3, while another end thereof is pivotally connected to the driving wheel 2, is such that the driving wheel 2 is in contact with an outer circumferential surface of the wheel 41 of the vehicle 4.

In addition, the fixing component 3 can comprise a latch 31 and a pin 32; the latch 31 is fixedly connected to the vehicle 4, and the pin 32 is assembled with and provided on the driving wheel 2 by means of the assembling pieces 36 and can be assembled with and connected to the latch 31.

In addition, the fixing component 3 comprises an insertion holder 33 and a first insertion piece 34; the first insertion piece 34 is fixedly connected to the vehicle 4, and the insertion holder 33 is assembled with and provided on the driving wheel 2 by means of the assembling pieces 36 and has a fastening piece 331, in which the fastening piece 331 is used to clamp and fasten the first insertion piece 34 on the insertion holder 33.

In addition, the fixing component 3 further has a second insertion piece 35, and the second insertion piece 35 is fixedly connected to the vehicle 4 and can be inserted into a detachable fender 42 for expansion.

In addition, the driving wheel 2 can be assembled with and provided on a lateral side of a hub 43 of the vehicle 4, and the fixing component 3 can be detachably or permanently assembled with and provided on a is frame, a front wheel fender or a rear wheel fender (not shown in the figures) of the vehicle 4. The light-emitting module 22 is a light-emitting diode module. When the vehicle 4 travels, the driving wheel 2 is rotated by means of the wheel 41 for driving the powering module 21 to generate an induced voltage, so as to provide an electrical energy to the light-emitting module 22, thereby providing an illuminating and warning effect; wherein the powering module 21 further has a stator and a plurality of coils (not shown in the figures), and when the driving wheel 2 rotates, the coils are rotated along and enabled to generate an alternating magnetic field with the stator, so as to generate an alternating current. This is a technology of the prior art and will not be described further here.

The invention disclosed above enables the present application to have the following advantages:
1. Self-powering is enabled during riding, and a battery is not required for providing illumination and a warning to the people and vehicles in the front and back.
2. The device can be detachably or fixedly connected to a vehicle, which is easy to disassemble and can satisfy the requirements of a shared use among several vehicles and anti-theft.
3. Has the function of power storage and can store power for use when required.
4. Has the function of brake warning.
5. Has the function of having a power generator and a light-emitting module integrated together, which solves the issues of a wiring requirement and noises in the dynamo of the conventional bicycles.
6. Has the physical message radio transceiving function and the voltage output function for use when required.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A self-powering warning device, comprising:
a driving wheel having at least one powering module and at least one light-emitting module provided therein, and the powering module can generate an induced voltage for driving the light-emitting module;
a fixing component capable of being assembled with and provided on a vehicle, and the driving wheel is pivotally connected to the fixing component and connected to a wheel of the vehicle, such that when the vehicle travels, the driving wheel is rotated by means of the wheel, so as to drive the powering module to generate the induced voltage for providing an electrical energy to the light-emitting module to produce an illuminating and warning effect.

2. The self-powering warning device of claim 1, wherein the driving wheel further has a voltage conversion module, and the voltage conversion module receives and converts the induced voltage into an output voltage for driving the light-emitting module.

3. The self-powering warning device of claim 2, wherein the driving wheel further has a power storage module and a voltage output module, in which the power storage module is coupled to the voltage conversion module and provides power storage, and the voltage output module is coupled to the voltage conversion module and supplies power to an external device.

4. The self-powering warning device of claim 3, wherein the driving wheel further has an action sensor module, a driver module and a brake light module, in which the action sensor module thereof is coupled to the powering module for detecting a rotation signal of the wheel, and the driver module is coupled to the action sensor module, the power storage module and the brake light module, such that when the action sensor module senses a braking signal, power is supplied to the driver module, by means of the power storage module, for driving the brake light module to generate a brake light illuminating and warning effect, wherein the braking signal is generated when the wheel of the vehicle decelerates or stops rotating.

5. The self-powering warning device of claim 4, wherein the driving wheel further comprises a radio transceiver module, and the radio transceiver module is coupled to the action sensor module and the power storage module, and transmits an action state of the vehicle to the external device.

6. The self-powering warning device of claim 1, wherein the fixing component comprises a latch and a pin, and the latch is fixedly connected to the vehicle, the pin is assembled with and provided on the driving wheel, and can be assembled with and connected to the latch.

7. The self-powering warning device of claim 1, wherein the fixing component comprises an insertion holder and a first insertion piece, in which the first insertion piece is fixedly connected to the vehicle, and the insertion holder is assembled with and provided on the driving wheel and has a fastening piece, and the fastening piece is used to clamp and fasten the first insertion piece on the insertion holder.

8. The self-powering warning device of claim 7, wherein the fixing component further has a second insertion piece, and the second insertion piece is fixedly connected to the vehicle and inserted into a detachable fender for expansion.

9. The self-powering warning device of claim 1, wherein the driving wheel can be assembled with and provided on a lateral side of a hub of the vehicle.

10. The self-powering warning device of claim 1, wherein the fixing component can be detachably or permanently assembled with and provided on a frame, a front wheel fender or a rear wheel fender of the vehicle, and the light-emitting module is a light-emitting diode module.
